(19) United States
(12) Patent Application Publication
(10) Pub. No.: US 2024/0332773 A1
(43) Pub. Date: Oct. 3, 2024

(54) WAVEGUIDE FOR RADIO FREQUENCY SIGNALS

(71) Applicant: HUAWEI TECHNOLOGIES CO., LTD., Shenzhen (CN)

(72) Inventors: Zhongxia Simon HE, Munich (DE); Hossein MASHAD NEMATI, Munich (DE)

(21) Appl. No.: 18/739,650

(22) Filed: Jun. 11, 2024

Related U.S. Application Data
(63) Continuation of application No. PCT/EP2021/085445, filed on Dec. 13, 2021.

(51) Int. Cl. H01P 3/14; H01P 5/103

(52) U.S. Cl. CPC H01P 3/14; H01P 5/103

(57) ABSTRACT

Example waveguide devices for guiding radio frequency signals are described. One example waveguide device includes an elongate flexible tubing having an elongate shape. The elongate flexible tubing includes an inner surface defining an elongate airtight cavity. The elongate airtight cavity extends from a first end of the elongate flexible tubing to a second end of the elongate flexible tubing. The first end is configured to couple the radio frequency signal into and/or out of the elongate airtight cavity. the inner surface of the elongate flexible tubing is configured to guide the radio frequency signal along the waveguide device. The second end is configured to couple the radio frequency signal out of and/or into the elongate airtight cavity. When the elongate airtight cavity is filled with a pressurized gaseous fluid, the elongate flexible tubing is configured to retain its elongate shape.

### CROSS-REFERENCE TO RELATED APPLICATIONS

This application is a continuation of International Application No. PCT/EP2021/085445, filed on Dec. 13, 2021, the disclosure of which is hereby incorporated by reference in its entirety.

### TECHNICAL FIELD

The present disclosure relates to equipment for communication. More specifically, the disclosure relates to a waveguide device for guiding radio frequency (RF) signals.

### BACKGROUND

Numerous communication, radar and/or sensing applications use signals in the millimeter wave (mmW) range, such as the 60-300 GHz frequency range. Due to the small wavelength, these signals radiate easily and attenuate easily. Different transmission lines (TL) are designed to support low loss signal transfer in a transverse electromagnetic (TEM) mode supported, for instance, by a coaxial cable or a transverse electric (TE) mode supported, for instance, by a waveguide. A waveguide normally has a lower loss than a coaxial cable TL.

A conventional waveguide usually has continuous metalized walls with a confined hollow inner area, which provides best performance in terms of a low loss. However, as these metalized walls are usually rigid, the shape of a such a waveguide cannot be adapted, for instance, to a specific use case of the waveguide, where it may be necessary to adjust the shape of the waveguide, i.e., having a flexible shape to a certain degree.

WO2019/243766 discloses interlock metalized sections for forming a semi-ridged waveguide that can bend, which, however, is rather heavy and costly.

### SUMMARY

It is an object to provide an improved waveguide device for guiding radio frequency (RF) signals with a flexible shape of the waveguide device.

The foregoing and other objects are achieved by the subject matter of the independent claims. Further implementation forms are apparent from the dependent claims, the description and the figures.

According to a first aspect, a waveguide device for guiding radio frequency signals is provided. The waveguide device comprises an elongate flexible tubing having an elongate shape, wherein the elongate flexible tubing comprises an inner surface defining an elongate airtight cavity, wherein the elongate airtight cavity extends from a first end of the elongate flexible tubing to a second end of the elongate flexible tubing. The first end of the elongate flexible tubing is configured to couple the radio frequency signal into and/or out of the elongate airtight cavity, wherein the inner surface of the elongate flexible tubing is configured to guide the radio frequency signal along the longitudinal axis of the waveguide device and wherein the second end of the elongate flexible tubing is configured to couple the radio frequency signal out of and/or into the elongate airtight cavity. The elongate flexible tubing is configured, when the elongate airtight cavity is filled with a pressurized gaseous fluid, in particular air, to retain its elongate shape.

The first aspect provides a flexible gas-filled waveguide device, wherein, for instance, pressurized air may be used to secure the cross-sectional shape of the waveguide device while the waveguide device is being bent in a direction substantially perpendicular to a longitudinal direction thereof. The waveguide device according to the first aspect allows providing low loss, flexible RF signal connections which enable system architectures that cannot be achieved with conventional less flexible TLs.

In a further possible implementation form, the inner surface of the elongate flexible tubing is a metallized inner surface. This allows to efficiently guide the radio frequency signal along the longitudinal direction of the waveguide device.

In a further possible implementation form, the inner surface of the elongate flexible tubing has a circular, rectangular, H-shaped or C-shaped cross section perpendicular to the longitudinal axis of the waveguide device. This allows to select the cross section best suited for a given use case of the waveguide device.

In a further possible implementation form, the elongate flexible tubing further comprises an outer isolation layer and a semi-rigid isolation material arranged between the outer isolation layer and the inner surface. This allows to electorally isolate the waveguide device from its surrounding.

In a further possible implementation form, the waveguide device further comprises one or more metallic conducting lines, wherein the one or more metallic conducting lines are embedded within the elongate flexible tubing of the waveguide device.

In a further possible implementation form, the one or more metallic conducting lines are embedded within an outer isolation layer of the elongate flexible tubing.

In a further possible implementation form, the metallic conducting lines are configured to transmit one or more control signals and/or power signals from the first end of the elongate flexible tubing to the second end of the elongate flexible tubing.

In a further possible implementation form, the elongate flexible tubing further comprises an openable pressurization hole connected to the airtight elongate cavity, wherein the airtight elongate cavity is configured to receive the pressurized fluid, when the openable pressurization hole is opened. This allows to efficiently fill the airtight elongate cavity, for instance, with pressurized air and to seal the pressurized air within the airtight elongate cavity.

In a further possible implementation form, the waveguide device further comprises a flange at the first end and/or the second end of the elongate flexible tubing, wherein the flange is scaled by an airtight gasket.

In a further possible implementation form, the waveguide device further comprises a waveguide-to-coax interface at the first end and/or the second end of the elongate flexible tubing.

In a further possible implementation form, the waveguide device further comprises an interface printed circuit board, PCB, at the first end and/or the second end of the elongate flexible tubing, wherein the interface PCB is configured to be soldered to a further PCB of a transmitter or receiver.

According to a second aspect a communication system is provided, comprising a transmitter configured to generate a radio frequency signal, a waveguide device according to the first aspect and a receiver configured to receive the radio frequency signal from the waveguide device.

According to a third aspect a method for guiding radio frequency signals is provided, wherein the method comprises the steps of:
providing a waveguide device with an elongate flexible tubing having an elongate shape, wherein the elongate flexible tubing comprises an inner surface defining an elongate airtight cavity, wherein the elongate airtight cavity extends from a first end of the elongate flexible tubing to a second end of the elongate flexible tubing, wherein the first end of the elongate flexible tubing is configured to couple the radio frequency signal into and/or out of the elongate airtight cavity, wherein the inner surface of the elongate flexible tubing is configured to guide the radio frequency signal along the waveguide device and wherein the second end of the elongate flexible tubing is configured to couple the radio frequency signal out of and/or into the elongate airtight cavity; and
filling the elongate airtight cavity with a pressurized gaseous fluid, in particular air for retaining the elongate shape of the elongate flexible tubing.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the invention are described in more detail with reference to the attached figures and drawings, in which:

FIG. 1 is a schematic perspective view of a waveguide device according to an embodiment;

FIGS. 2a-c show schematic cross sections of a waveguide device according to different embodiments;

FIG. 3 is a schematic cross section of a waveguide device according to an embodiment for interfacing with a coax TL;

FIGS. 4a and 4b show schematic views of embodiments of a sealing gasket of the waveguide device of FIG. 3;

FIG. 5 is a schematic cross section of a waveguide device according to an embodiment for interfacing with another waveguide TL;

FIG. 6 is a schematic cross section of a waveguide device according to an embodiment for interfacing with a printed circuit board;

FIG. 7 shows a schematic cross section of a waveguide device according to a further embodiment;

FIGS. 8a-c show schematic diagrams illustrating a communication system according to an embodiment including a waveguide device according to an embodiment; and

FIG. 9 shows a flow diagram illustrating steps of a method for guiding radio frequency signals according to an embodiment.

In the following identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

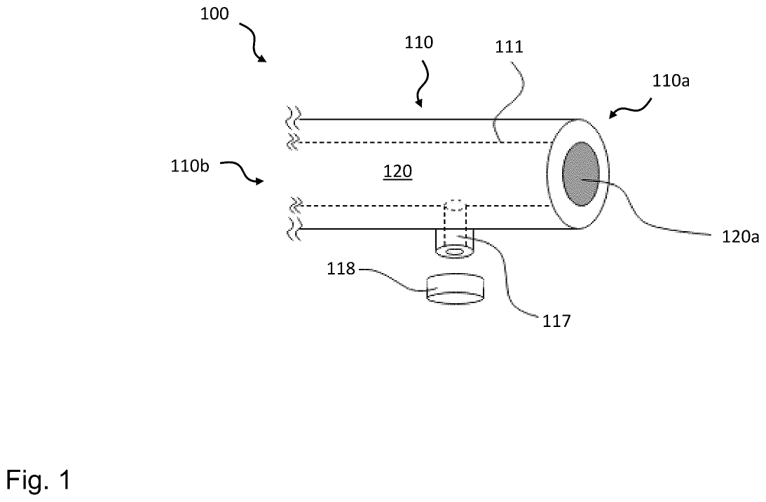

FIG. 1 is a schematic perspective view of a waveguide device 100 according to an embodiment for guiding radio frequency signals, for instance, signals with frequencies in the millimeter wave (mmW) range, such as the 60-300 GHz frequency range. As illustrated in FIG. 1, the waveguide device 100 comprises an elongate flexible tubing 110 having an elongate shape.

The elongate flexible tubing 110 comprises an inner surface (or inner surface layer) 111 defining an elongate airtight cavity 120. The elongate airtight cavity 120 extends from a first end 110a of the elongate flexible tubing 110 (in FIG. 1 the end on the right end side) along a longitudinal direction of the waveguide device 100 to a second end 110b of the elongate flexible tubing 110 (in FIG. 1 the end on the left end side). The first end 110a of the elongate flexible tubing 110 is configured to couple the radio frequency signals into and/or out of the elongate airtight cavity 120, while the inner surface 111 of the elongate flexible tubing 110 is configured to guide the radio frequency signal along the longitudinal direction of the waveguide device 100 and the second end 110b of the elongate flexible tubing 110 is configured to couple the radio frequency signal out of and/or into the elongate airtight cavity 120. In an embodiment, the inner surface 111 of the elongate flexible tubing 110 is a metallized inner surface 111, i.e. comprising a metallized surface layer 111. The metallized surface layer 111 may be provided with conductive painting, electroplating, or as an adhesive conductive layer. In a further embodiment, the whole elongate flexible tubing 110 may comprise a conductive flexible material.

As will be described in more detail below, when the elongate airtight cavity 120 is filled with a pressurized gaseous fluid, for instance, with pressurized air, the elongate flexible tubing 110 is configured to substantially retain its elongate shape. For filling the pressurized gaseous fluid, e.g. pressurized air into the elongate airtight cavity 120 the waveguide device shown in FIG. 1 further comprises an openable pressurization hole 117 connected to the airtight elongate cavity 120. The airtight elongate cavity 120 is configured to receive the pressurized fluid, e.g. the pressurized air, when the openable pressurization hole 117 is opened. As illustrated in FIG. 1, the waveguide device 100 may further comprise a scaling cap 118 for an airtight closing and opening of the pressurization hole 117. In an embodiment, the pressurization hole 117 has a diameter that is smaller than 30% of a linear dimension, e.g. a diameter of the cross section 120a of the airtight elongate cavity 120 in order to minimize its impact on the RF transmission performance.

The elongate flexible tubing 110 of the waveguide device 100 shown in FIG. 1 may be manufactured using a low cost material, where any transmission loss is purely depending on the metallized surface layer 111. As will be appreciated, by filling the airtight elongate cavity 120, for instance, with pressured air, the elongate flexible tubing 110 can substantially sustain its internal cross sectional shape, even when exposed to bending forces. Yet the structure is flexible to be bend to some degree and therefore suitable for different installation scenarios. The pressurization hole 117 may be used to inflate the airtight elongate cavity 120 after deployment of the waveguide device 100. Before pressurization the waveguide device 100 is more flexible for deployment, while after inflation the rigidity of the waveguide device 100 is increased to avoid substantial changes of its elongate shape. The pressurization hole 117 may further be used for RF signal probing and problem diagnosis.

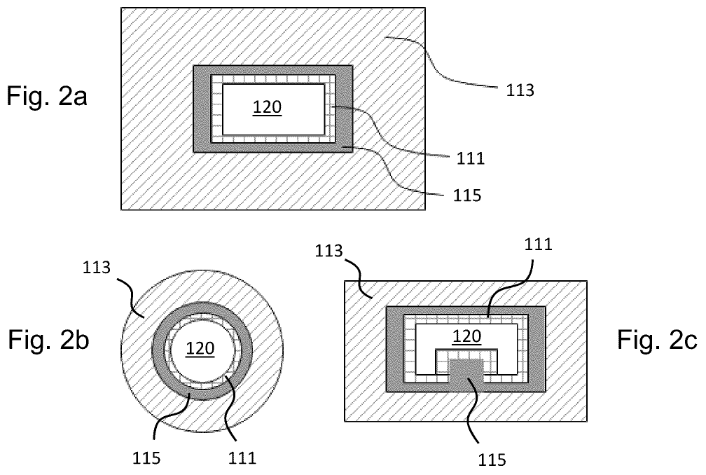

In the embodiment shown in FIG. 1, the metallized inner surface 111 of the elongate flexible tubing 110 has a circular cross section such that a cross section 120a of the elongate airtight cavity 120 is circular as well (also shown in the embodiment of FIG. 2b). In the further embodiments shown in FIGS. 2a and 2c the metallized inner surface 111 of the elongate flexible tubing 110 (or the elongate airtight cavity 120) has a rectangular or C-shaped cross section 120a in order to support a TE mode propagation of the RF signals along the elongate flexible tubing 120. For example, for 60-90 GHz signal transmission, rectangular shaped cross section with dimensions of 3.2 mm×1.6 mm may be used. In a further embodiment, the cross section of the metallized inner surface 111 of the elongate flexible tubing 110 (or the elongate airtight cavity 120) may be H-shaped.

In the embodiments shown in FIGS. 2a-c, the elongate flexible tubing 110 comprises, in addition to the metallized inner surface layer 111, an outer isolation layer 113 and a semi-rigid isolation material 115 arranged between the outer isolation layer 113 and the inner surface layer 111.

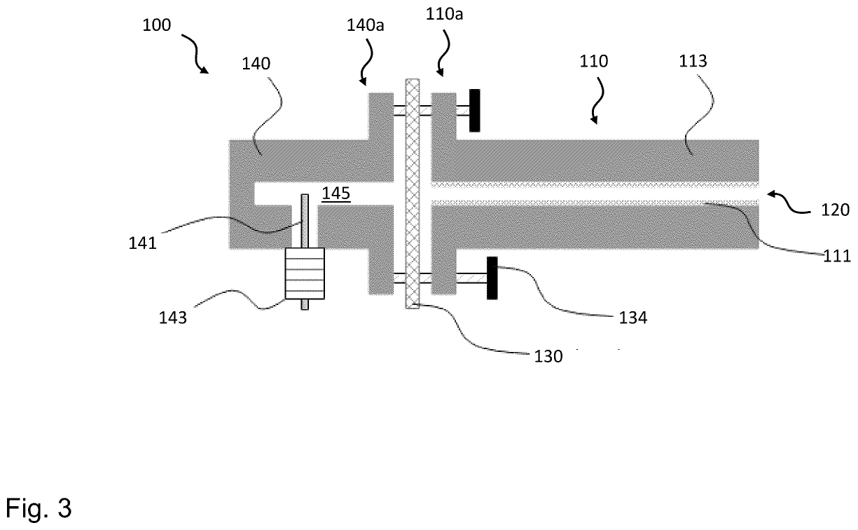

FIG. 3 is a schematic cross section of the waveguide device 100 according to an embodiment, wherein the waveguide device 100 further comprises a waveguide-to-coax interface 140 for coupling the waveguide device 100 with a coax TL. In the embodiment shown in FIG. 3, the waveguide-to-coax interface 140 is arranged, by way of example, at the first end 110a of the elongate flexible tubing 110. For connecting the first end 110a of the elongate flexible tubing 110 to the waveguide-to-coax interface 140 the first end 110a of the elongate flexible tubing 110 may comprise a flange portion configured to be connected to a flange 140a of the waveguide-to-coax interface 140. As illustrated in FIG. 3, the flange 140a of the waveguide-to-coax interface 140 may be fastened to the flange portion of the first end 110a of the elongate flexible tubing 110 by means of one or more fastening screws 134. For keeping the cavity 120 airtight an airtight sealing gasket 130 may be arranged between the flange 140a of the waveguide-to-coax interface 140 and the flange portion of the first end 110a of the elongate flexible tubing 110.

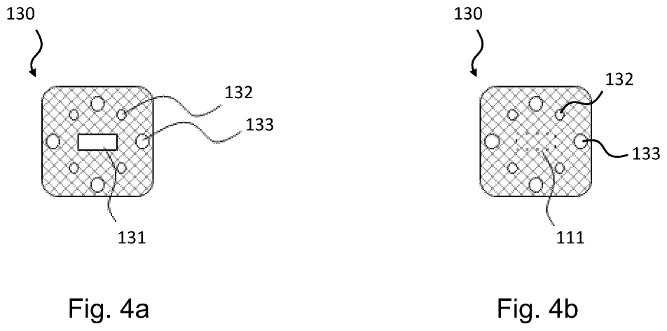

FIGS. 4a and 4b show schematic views of respective embodiments of the scaling gasket 130 of the waveguide device 100 of FIG. 3. In the embodiment of the sealing gasket 130 shown in FIG. 4a the sealing gasket 130 may comprise a rectangular opening 131 having the same cross section as the airtight cavity 120 defined by the inner surface 111 of the elongate flexible tubing 110, one or more alignment pin holes 132 for receiving one or more alignment pins (not shown in FIG. 3) extending from the flange 140a of the waveguide-to-coax interface 140 and/or the flange portion of the first end 110a of the elongate flexible tubing 110, and one or more screw holes 133 for receiving the one or more fastening screws 135. The sealing gasket 130 in this embodiment has to be airtight, both metallic and non-conductive material can be used.

In the embodiment of the sealing gasket 130 shown in FIG. 4b the sealing gasket 130 may comprise the one or more alignment pin holes 132 for receiving one or more alignment pins (not shown in FIG. 3) extending from the flange 140a of the waveguide-to-coax interface 140 and/or the flange portion of the first end 110a of the elongate flexible tubing 110 and the one or more screw holes 133 for receiving the one or more fastening screws 135, but not the rectangular opening 131 (the position of the inner surface 111 of the elongate flexible tubing 110 is marked by the dashed line in FIG. 4b). The sealing gasket 130 without the opening 131 may comprise a material that is airtight and has a low dielectric constant. As will be appreciated, the thickness of the sealing gasket 130 shown in FIG. 4b may have an impact on the RF signal interface loss and, therefore, may be chosen as small as possible.

As can be taken from FIG. 3, the waveguide-to-coax interface 140 comprises a cavity 145, which may have the same cross sectional shape as the airtight cavity 120 defined by the inner surface 111 of the elongate flexible tubing 110 (but which because of the airtight scaling gasket 130 no longer has to be sealed). Radio frequency signals being guided towards the first end 110a of the elongate flexible tubing 110 pass through the sealing gasket 130 into the cavity 145 of the waveguide-to-coax interface 140 and are coupled into signalling pin or line 141 of a coax TL, which may be connected to the waveguide-to-coax interface 140 by means of a coax TL connector 143.

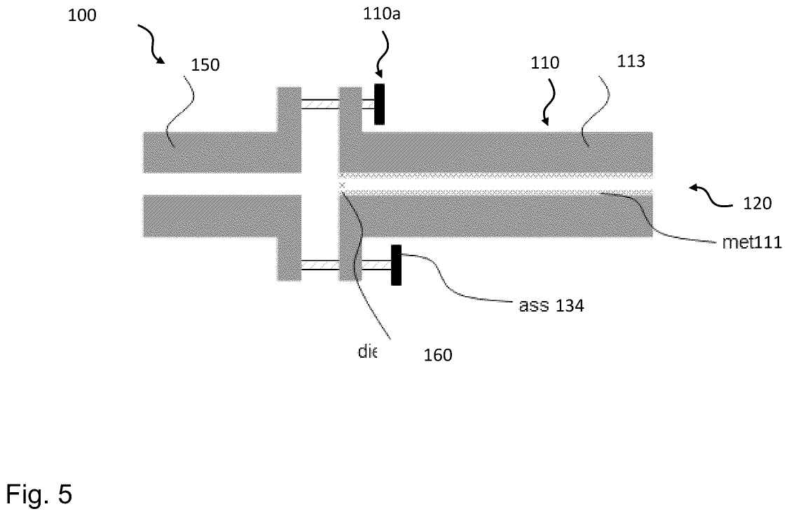

FIG. 5 is a schematic cross section of the waveguide device 100 according to a further embodiment for interfacing with a waveguide TL 150. The embodiment shown in FIG. 5 differs from the embodiment shown in FIG. 3 in that the waveguide-to-coax interface 140 of the embodiment of FIG. 3 is replaced by the waveguide TL 150 and in that the sealing gasket 30 of the embodiment of FIG. 3 is replaced by a dielectric seal 160 arranged within the airtight elongate cavity 120. In an embodiment the thickness of the dielectric seal 160 arranged within the airtight elongate cavity 120 is smaller than ⅛ of the wavelength of the central frequency of the RF signals.

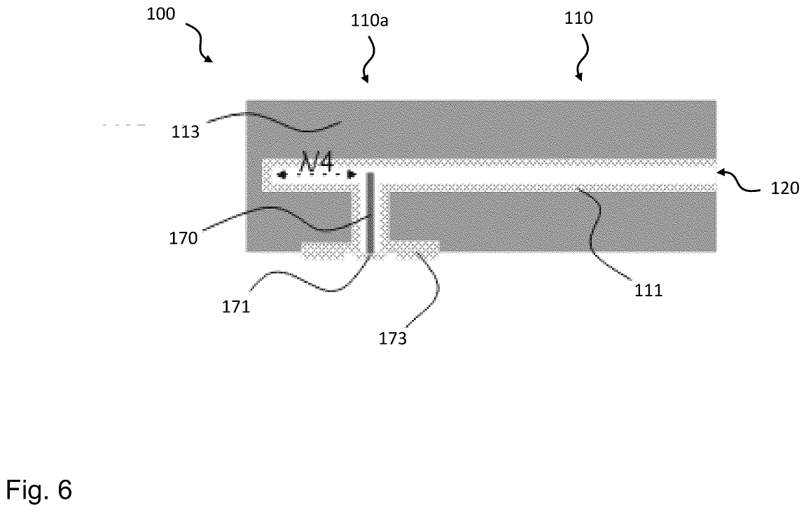

FIG. 6 is a schematic cross section of the waveguide device 100 according to an embodiment for interfacing with a printed circuit board. In the embodiment shown in FIG. 6 one end of a signalling pin 170 is arranged within the airtight elongate cavity 120 for receiving RF signals being guided along the longitudinal direction of the waveguide device 100, while the other end of the signalling pin 170 is connected to an interface printed circuit board, PCB, 171. In an embodiment, the interface PCB 171 may comprise a signalling pad configured to be connected, e.g., soldered to a further PCB of a transmitter or receiver. In an embodiment, the interface PCB 171 may further comprise a ground pad 173. In an embodiment, the signalling pin 170 may be arranged at a distance of about ¼ of the wavelength of the central frequency of the RF signals from the closest end of the airtight elongate cavity 120. The metal signalling pin 170 and the interface PCB 171 may be inserted through an inspection hole and sealed with a dielectric material. In the embodiment shown in FIG. 6, the inner metallization surface layer 111 extends around the signalling pin 170 with dielectric material in between in order to form a coaxial TL to feed the RF signals to the outside of the elongate flexible tubing 111. As already described above, outside of the elongate flexible tubing 111 the signalling pin 170 and a ground may connect to signal pads 171 and ground pads 173 configured to be soldered to a further PCB. Alternatively, the signalling pin 170 may be directly soldered to the further PCB.

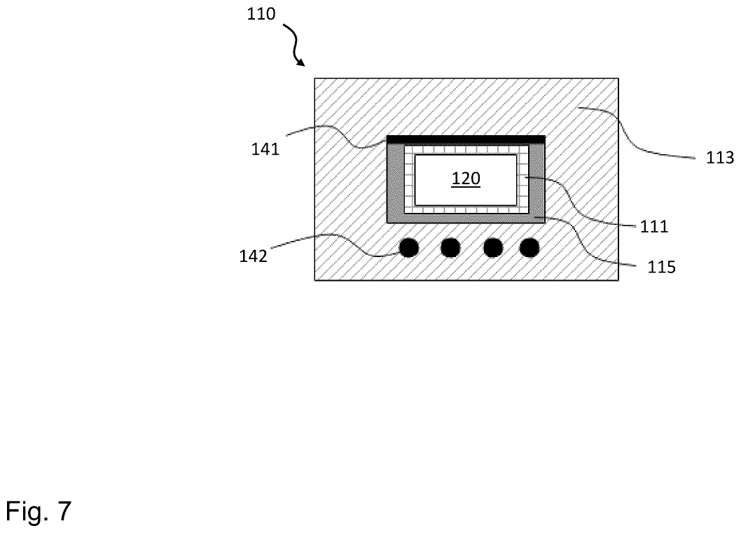

FIG. 7 shows a schematic cross section of the waveguide device 100 according to a further embodiment. In the embodiment shown in FIG. 7, the waveguide device 100 further comprises one or more metallic conducting lines 141, 142, which may comprise one or more power signalling lines configured to transmit one or more power signals from the first end 110a of the elongate flexible tubing 110 to the second end 110b of the elongate flexible tubing 110 and/or one or more control signalling lines configured to transmit one or more control and/or data signals from the first end 110a of the elongate flexible tubing 110 to the second end 110b of the elongate flexible tubing 110. In the embodiment shown in FIG. 7 the metallic conducting lines 141, 142 are embedded within the outer isolation layer 113 of the elongate flexible tubing 110 and extend along the waveguide device 110, either as separate metallic lines 142 or a further metallization layer 141 on the outer surface of the flexible tube material.

The one or more metallic conducting lines 141, 142 of the waveguide device 100 shown in FIG. 7 not only provide additional communication bandwidth, but also enhance the rigidity of the elongate flexible tubing 110 for avoiding a collapse of the cross-section upon bending. Moreover, when synchronizing different communication nodes via the waveguide device 100 with the same RF signal source, it is important to align the phase of the RF signals at the remote ends. When waveguide devices 100 with different lengths are used for synchronization, the signalling lines 141, 142 embedded in the respective flexible tubing 111 have the same length as the respective flexible tubing 111 Consequently, these waveguide devices 100 may be more easily calibrated in a way that low frequency control signals reach remote end simultaneously as the mmW signals to ensure operation such as switching/modulation/amplification/attenuation with the correct timing.

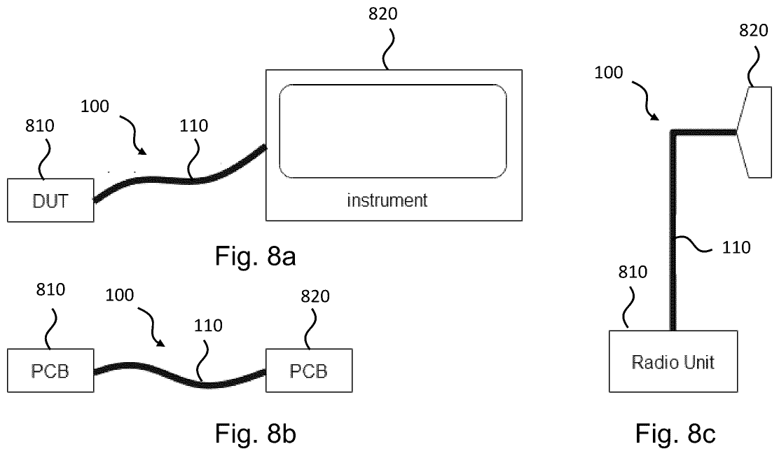

FIGS. 8a-c show schematic diagrams illustrating a respective communication system 800 according to an embodiment including the waveguide device 100 according to an embodiment. The communication systems 800 shown in FIGS. 8a-c comprise a transmitter 810 configured to generate a radio frequency signal, the waveguide device 100 according to an embodiment for guiding the radio frequency signal, and a receiver 820 configured to receive the radio frequency signal from the waveguide device 100. As illustrated in FIGS. 8a-c the transmitter 810 and/or the receiver may comprise one or more of the following: a device under test (DUT), an electronic instrument, a PCB, a radio unit, a radio antenna and the like.

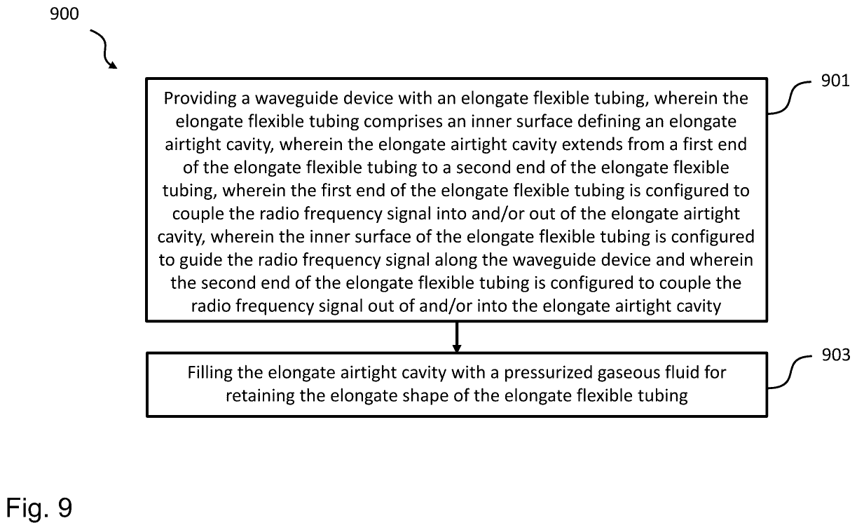

FIG. 9 shows a flow diagram illustrating steps of a method 900 according to an embodiment for guiding radio frequency signals. The method 900 comprises a step 901 of providing the waveguide device 100 with the elongate flexible tubing 110. As already described above, the elongate flexible tubing 110 comprises the inner surface 111 defining the elongate airtight cavity 120, wherein the elongate airtight cavity 120 extends from the first end 110a of the elongate flexible tubing 110 to the second end 110b of the elongate flexible tubing 110. The first end 110a of the elongate flexible tubing 110 is configured to couple the radio frequency signals into and/or out of the elongate airtight cavity 120. The inner surface 111 of the elongate flexible tubing 110 is configured to guide the radio frequency signals along the waveguide device 100 and the second end 110b of the elongate flexible tubing 110 is configured to couple the radio frequency signal out of and/or into the elongate airtight cavity 120. The method 900 comprises a further step 903 of filling the elongate airtight cavity 120 with a pressurized gaseous fluid, in particular pressurized air, for retaining the elongate shape of the elongate flexible tubing 110.

The person skilled in the art will understand that the “blocks” (“units”) of the various figures (method and apparatus) represent or describe functionalities of embodiments (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments may be integrated into one processing unit, or each of the units may exist alone physically, or two or more units are integrated into one unit.

1. A waveguide device for guiding radio frequency signals, wherein the waveguide device comprises:
an elongate flexible tubing having an elongate shape and comprising an inner surface defining an elongate airtight cavity, wherein:
the elongate airtight cavity extends from a first end of the elongate flexible tubing to a second end of the elongate flexible tubing,
the first end of the elongate flexible tubing is configured to perform at least one of coupling the radio frequency signals into or coupling the radio frequency signals out of the elongate airtight cavity,
the inner surface of the elongate flexible tubing is configured to guide the radio frequency signals along the waveguide device, and
the second end of the elongate flexible tubing is configured to perform at least one of coupling the radio frequency signals out of or coupling the radio frequency signals into the elongate airtight cavity;
wherein, when the elongate airtight cavity is filled with a pressurized gaseous fluid, the elongate flexible tubing is configured to retain an elongate shape.

2. The waveguide device of claim 1, wherein the inner surface of the elongate flexible tubing is a metallized inner surface.

3. The waveguide device of claim 1, wherein the inner surface of the elongate flexible tubing has a circular, rectangular, H-shaped, or C-shaped cross section.

4. The waveguide device of claim 1, wherein the elongate flexible tubing further comprises an outer isolation layer and a semi-rigid isolation material arranged between the outer isolation layer and the inner surface.

5. The waveguide device of claim 1, wherein the waveguide device further comprises one or more metallic conducting lines, wherein the one or more metallic conducting lines are embedded within the elongate flexible tubing and extend along the waveguide device.

6. The waveguide device of claim 5, wherein the one or more metallic conducting lines are embedded within an outer isolation layer of the elongate flexible tubing.

7. The waveguide device of claim 5, wherein the one or more metallic conducting lines are configured to transmit at least one of control signals or power signals from the first end of the elongate flexible tubing to the second end of the elongate flexible tubing.

8. The waveguide device of claim 1, wherein the elongate flexible tubing further comprises an openable pressurization hole connected to the airtight elongate cavity, and wherein the airtight elongate cavity is configured to receive the pressurized gaseous fluid when the openable pressurization hole is opened.

9. The waveguide device of claim 1, wherein the waveguide device further comprises a flange at at least one of the first end or the second end of the elongate flexible tubing, wherein the flange is sealed by a sealing gasket.

10. The waveguide device of claim 1, wherein the waveguide device further comprises a waveguide-to-coax interface at at least one of the first end or the second end of the elongate flexible tubing.

11. The waveguide device of claim 1, wherein the waveguide device further comprises an interface printed circuit board (PCB) at at least one of the first end or the second end of the elongate flexible tubing, wherein the interface PCB is configured to be soldered to a further PCB of a transmitter or receiver.

12. A communication system, comprising:
a transmitter configured to generate a radio frequency signal;
a waveguide device; and
a receiver configured to receive the radio frequency signal from the waveguide device;
wherein the waveguide device comprises an elongate flexible tubing having an elongate shape and comprising an inner surface defining an elongate airtight cavity, and wherein:
the elongate airtight cavity extends from a first end of the elongate flexible tubing to a second end of the elongate flexible tubing,
the first end of the elongate flexible tubing is configured to perform at least one of coupling the radio frequency signals into or coupling the radio frequency signals out of the elongate airtight cavity,
the inner surface of the elongate flexible tubing is configured to guide the radio frequency signals along the waveguide device, and
the second end of the elongate flexible tubing is configured to perform at least one of coupling the radio frequency signals out of or coupling the radio frequency signals into the elongate airtight cavity;
wherein, when the elongate airtight cavity is filled with a pressurized gaseous fluid, the elongate flexible tubing is configured to retain an elongate shape.

13. The communication system of claim 12, wherein the inner surface of the elongate flexible tubing is a metallized inner surface.

14. The communication system of claim 12, wherein the inner surface of the elongate flexible tubing has a circular, rectangular, H-shaped, or C-shaped cross section.

15. The communication system of claim 12, wherein the elongate flexible tubing further comprises an outer isolation layer and a semi-rigid isolation material arranged between the outer isolation layer and the inner surface.

16. The communication system of claim 12, wherein the waveguide device further comprises one or more metallic conducting lines, wherein the one or more metallic conducting lines are embedded within the elongate flexible tubing and extend along the waveguide device.

17. The communication system of claim 16, wherein the one or more metallic conducting lines are embedded within an outer isolation layer of the elongate flexible tubing.

18. The communication system of claim 16, wherein the one or more metallic conducting lines are configured to transmit at least one of control signals or power signals from the first end of the elongate flexible tubing to the second end of the elongate flexible tubing.

19. The communication system of claim 12, wherein the elongate flexible tubing further comprises an openable pressurization hole connected to the airtight elongate cavity, and wherein the airtight elongate cavity is configured to receive the pressurized gaseous fluid when the openable pressurization hole is opened.

20. A method for guiding radio frequency signals, wherein the method comprises:
providing a waveguide device with an elongate flexible tubing, wherein the elongate flexible tubing comprises an inner surface defining an elongate airtight cavity, and wherein:
the elongate airtight cavity extends from a first end of the elongate flexible tubing to a second end of the elongate flexible tubing,
the first end of the elongate flexible tubing is configured to perform at least one of coupling the radio frequency signals into or coupling the radio frequency signals out of the elongate airtight cavity,
the inner surface of the elongate flexible tubing is configured to guide the radio frequency signals along the waveguide device, and
the second end of the elongate flexible tubing is configured to perform at least one of coupling the radio frequency signals out of or coupling the radio frequency signals into the elongate airtight cavity; and
filling the elongate airtight cavity with a pressurized gaseous fluid for retaining an elongate shape of the elongate flexible tubing.
